(19) United States
(12) Patent Application Publication
(10) Pub. No.: US 2014/0116812 A1
(43) Pub. Date: May 1, 2014

(54) SAFETY VALVE FOR TRAILER

(71) Applicant: Edwin Bernard Simpson, Graysville, GA (US)

(72) Inventor: Edwin Bernard Simpson, Graysville, GA (US)

(21) Appl. No.: 13/969,209

(22) Filed: Aug. 16, 2013

Related U.S. Application Data
(60) Provisional application No. 61/684,272, filed on Aug. 17, 2012.

(51) Int. Cl. B60T 15/36; B60T 17/22

(52) U.S. Cl. CPC B60T 15/36; B60T 17/22
USPC 188/1.11 R; 303/84.2

(57) ABSTRACT

A device and method to override a conventional trailer emergency brake system that may include a safety valve to override the brake valve located in a tractor. A preferred safety valve may be located in a sidewall of a trailer. In one position, a preferred safety valve may prevent compressed air from being transmitted to the trailer parking brakes so that a truck driver is unable to release the trailer brakes. In another position, a preferred safety valve may divert compressed air to one or more devices to alert a driver, a dock worker or others of an effort to release the trailer parking brakes. In another position, a preferred safety valve may permit compressed air to be transmitted so that a truck driver is able to release the trailer brakes.

This application claims the benefit of U.S. Provisional Patent Application No. 61/684,272, filed on Aug. 17, 2012, entitled “SAFETY VALVE FOR TRAILER,” the disclosure of which is expressly incorporated herein by reference in its entirety.

### FIELD OF THE INVENTION

The present invention relates generally to the braking systems of a trailer intended to be operatively attached to a tractor for hauling goods over the roads. More particularly, the present invention relates to a novel safety system that, when engaged, is capable of alerting and/or preventing inadvertent movement of the trailer.

### BACKGROUND OF THE INVENTION

Tractor trailer or “semi” trailer tracks are well known and widely used to haul a wide range of goods across great distances. A conventional tractor trailer truck includes a tractor that pulls a trailer. A conventional tractor includes an engine, a cabin for the driver and, in some instances, a sleeper compartment. A conventional trailer is used to haul a variety of goods and may take various forms, ranging from a box-like container with an enclosed cargo space to a flatbed to a car hauler. The prior art also includes box trucks that provide a truck with an attached bed. As described herein, the present invention is applicable to all trucks and vehicles that utilize air brakes.

Due to their substantial size and weight, trucks conventionally use air pressure, rather than standard hydraulic fluid, to actuate the brakes. Not only does an air pressure brake system provide greater braking power, it reduces the potential for certain problems with conventional hydraulic brake systems such as leakage or vaporization of the hydraulic brake fluid. Further, because the tractor brake system may be connected with the trailer brake system, it is more convenient to use an air pressure system because it allows for a tractor to be connected to multiple trailers.

The parking brake of the tractor and the emergency brake of the trailer are conventionally spring brakes that also operate on air pressure. The springs cause the brakes to be applied. More particularly, the tractor's parking brake and the trailer's emergency brake require air pressure in order to be released. When air pressure is applied to the tractor trailer truck braking system, the parking brake and the emergency brake are released. In contrast, when air pressure is released from the tractor trailer truck braking system, the parking brake and the emergency brake are applied by action of the springs. In this way, the truck driver may be assured that if air pressure is inadvertently released or lost from the braking system, the trailer will brake to a stop instead of not being braked and, perhaps, becoming uncontrollable.

Further, a truck driver conventionally applies tractor and trailer parking brakes by operating valves that either deliver or release compressed air to the brake system. More particularly, a tractor conventionally includes a tractor parking brake valve and a trailer parking brake valve. Once the driver has positioned the tractor and trailer as desired, the driver will manipulate the tractor parking brake valve to release compressed air from the tractor brake system and thereby apply the tractor parking brakes. Similarly, the driver will manipulate the trailer parking brake valve to release compressed air from the trailer brake system and thereby apply the trailer parking brakes. It is also known to provide for the two valves to cooperate such that when the truck driver manipulates the tractor parking brake valve, the trailer parking brake valve is simultaneously activated so that both the tractor and trailer parking brakes are applied. With specific reference to the parking or emergency brake for the trailer, the valve is manipulated by the truck driver to supply compressed air to the trailer emergency brake system and release the brakes. In this manner, the truck driver can release the trailer emergency brake in order to pull the trailer away from the dock. By virtue of the foregoing arrangement, the truck driver is also able to release the tractor parking brake and pull the tractor away from the trailer without releasing the trailer parking brakes. Once the truck driver re-connects the tractor to the trailer and seeks to again move the trailer, the driver can manipulate the trailer emergency brake valve (in the tractor) to deliver compressed air to the trailer brake system and release the parking brakes.

In use, a trailer is conventionally loaded and unloaded at a loading dock. The tractor trailer truck operator maneuvers the trailer into position by backing the tractor and trailer up against the loading dock in such a way that the dock surface is substantially level with the surface of the trailer. The rearward most portion of the trailer is positioned adjacent to the loading dock so that a forklift or like equipment may be driven onto the trailers floor surface to unload or load the trailer.

A safety problem exists in the loading or unloading of trailers. For example, if a trailer is moved away from the dock before the forklift operator or other dock worker completes loading or unloading of the trailer, the dock worker or equipment may be jeopardized. The worker or product or forklift may fall between the rear edge of the trailer and the loading dock, causing harm to the worker or damage to the goods or the equipment. The truck driver may inadvertently pull the trailer away from the dock without knowing or realizing that the loading or unloading process is not complete. For these and other reasons, it is preferable that a trailer not be prematurely or inadvertently pulled away from the dock, or that the truck driver be alerted to the fact that the trailer is in use. There is a need in the art for a device and method that addresses premature or inadvertent movement of a trailer from a dock.

### SUMMARY OF THE INVENTION

The present invention addresses the premature or inadvertent movement of a trailer positioned at a dock. More particularly, the present invention includes a device and method that may be engaged or practiced by a tractor trailer truck driver, a forklift operator, a dock worker or other person to override the conventional trailer emergency brake system so as to preclude and alert others as to inadvertent or premature movement of the trailer.

Described somewhat more particularly, a preferred embodiment of the present invention includes a safety valve operatively positioned in the emergency brake system of a trailer system that may be engaged to override the trailer parking brake valve located in the tractor to prevent the truck driver from prematurely or inadvertently moving the trailer and/or to alert the driver, a dock worker or others of any premature or inadvertent moving of the trailer. A safety valve according to the present invention is preferably located in a sidewall of a trailer so as to be accessible from only the interior of the trailer. By manipulation of the preferred safety valve to a closed position, compressed air is prevented from being transmitted to the trailer brake system components such that the truck driver is unable to release the trailer brakes. Moreover, when the preferred safety valve is in a closed position, compressed air is diverted to means for alerting the driver, a dock worker or others before the trailer could be moved. By manipulation of the safety valve to an open position, compressed air is transmitted to the trailer brake system and the truck driver is able to release the trailer brakes and, correspondingly, move the trailer.

In an alternative preferred embodiment, a preferred safety valve includes multiple chambers, wherein one chamber is utilized to activate an alert flag positioned in a readily viewable location, such as the outside front portion of the trailer, so as to alert a driver or other individual that the trailer is in use and should not be moved. If compressed air is delivered to this chamber of the safety valve, and the valve is in an open position, this embodiment of the invention causes a notification to be displayed stating, for example, that the trailer is in use and should not be moved.

In another alternative preferred embodiment, a preferred safety valve is provided in a compartment that includes an alert whistle or an air horn or any other air powered alerting device that is activated to alert a fork lift operator or other individual at or near the dock that the trailer could be moved. If compressed air is delivered to the safety valve, this embodiment of the invention causes the whistle to sound an alert.

In yet another alternative preferred embodiment, a preferred safety valve includes one or more air horns or alert whistle or other air powered aural device that may be positioned on the outside front portion of the trailer so as to be readily heard by a truck driver or other individual near the tractor. If compressed air is delivered to the safety valve, this embodiment of the invention causes the air horns to sound on alert. In yet another alternative preferred embodiment, a preferred safety valve includes a visual alert that is activated in response to compressed air diverted by the safety valve.

In yet another alternative preferred embodiment, the safety valve of the present invention may be placed in any suitable location on the trailer and responsive to a remote activation device such as an electrical switch on the inside wall of the trailer that would cause the safety valve to close and open. In such an embodiment, manipulation of the electrical switch would cause the safety valve to close and prevent compressed air from being transmitted to and releasing the trailer parking brake. Conversely, another manipulation of the electrical switch would cause the safety valve to open and allow compressed air to be delivered to the trailer parking brake system so as to release the trailer parking brake. The position of the safety valve is thus variable. The switch may be located on the inside wall of the trailer.

In yet another preferred embodiment, a preferred safety valve would be associated with a release valve that may be provided on the exterior of the trailer (for example, on the bottom of the trailer) so as to override or open the safety valve in the event the trailer is locked and the safety valve is not accessible. Such a release valve would allow a truck driver to release the trailer parking brakes without access to the safety valve.

Thus, it is an object of the present invention to address and enhance the safe use of tractor trailer trucks.

It is a further object of the present invention to address problems associated with premature or inadvertent movement of a trailer attached or connected to a tractor.

It is a further object of the present invention to provide a safety device that allows one to override the trailer brake release mechanism such that a truck driver cannot inadvertently or prematurely move a trailer at a loading dock.

It is a further objet to alert a truck driver, fork lift operator or other dock worker of an inadvertent or premature or other possible movement of a trailer.

It is a further object of the present invention to remotely override the trailer emergency brake release valve that is conventionally provided in a tractor.

It is a further object of the present invention to utilize the compressed air in a tractor trailer truck brake system to operate a remote safety valve that is able to override the emergency brake valve in a tractor and to alert a truck driver or other individual that the trailer is in use and is preferable not to be moved.

It still is a further object of the present invention to alert a truck driver or other individual whether a trailer is in use when the truck driver operates the emergency brake valve in a tractor by providing both visual and aural notification of any such use.

The details of one or more embodiments are set forth in the accompanying drawings and the detailed description herein. Other features, objects and advantages of the invention will be apparent from this description, the drawings and claims.

### DESCRIPTION OF THE DRAWING

FIG. 1 is a pictorial representation of a tractor trailer truck including a safety valve in accordance with the present invention.

FIG. 2 is a schematic representation of a trailer brake system including a safety valve in accordance with the present invention.

FIG. 3 is a schematic representation of a trailer brake system including a front view of a compartment containing a safety valve in accordance with the present invention.

FIG. 4 is a representation of a flag or alert notice provided in a compartment with an aural device that may be provided in accordance with the present invention.

FIG. 5 is a schematic representation of a compartment containing a safety valve in accordance with the present invention as utilized in conjunction with a trailer brake system.

### DETAILED DESCRIPTION

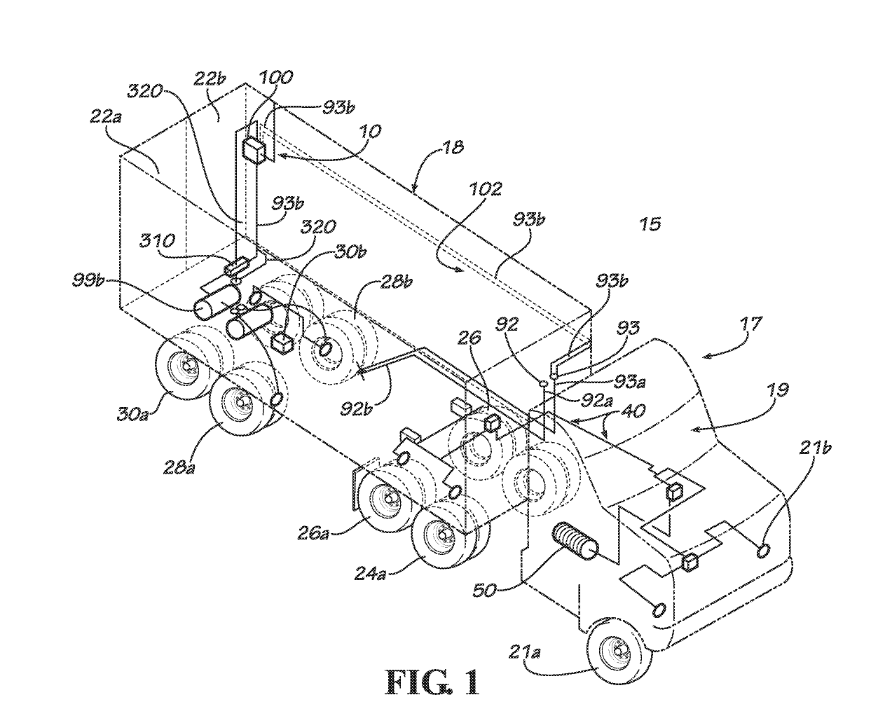

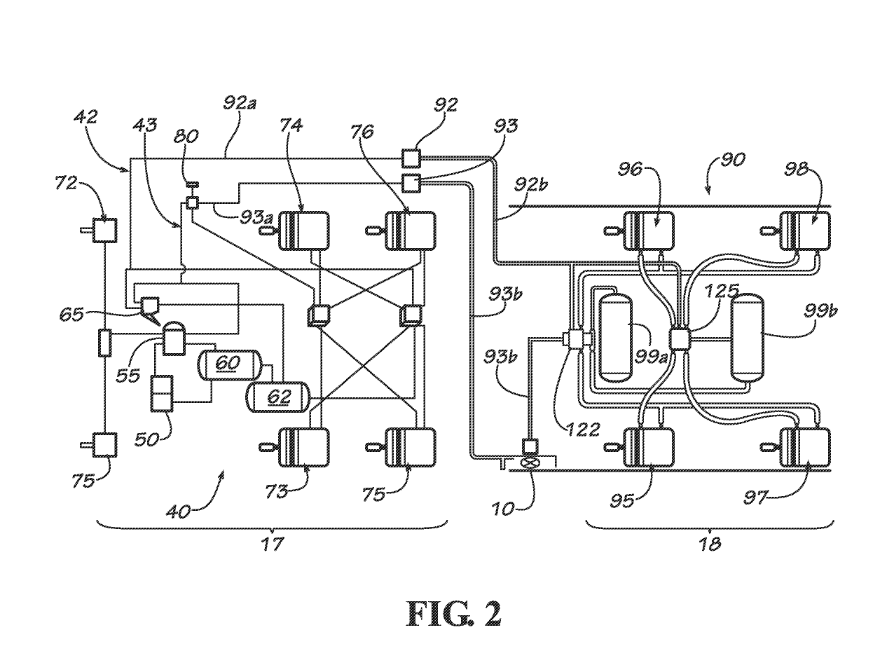

Referring now in more detail to the drawings, in which like numerals indicate like parts throughout the several figures, FIG. 1 shows a safety valve in accordance with the present invention generally at 10 provided with a tractor trailer truck 15. The tractor trailer truck 15 includes a tractor 17 and a trailer 18. The tractor 17 includes an engine (not shown) and a cabin 19 in which a truck driver sits to drive the tractor trailer truck 15. The tractor 17 has three axels, the forward most axel supports two wheels 21a and 21b at the forward end of the tractor 17. The tractor 17 further includes two rear axels that support two sets of tires 24a, 24b (not shown), and 26a, 26b (not shown) that rest below the forward portion of the trailer 18. The trailer 18 is a box-like trailer that is well known and able to haul a variety of goods. The rear wall of the trailer 18 conventionally provides doors 22a and 22b for loading and unloading, including by means of a forklift (not shown). It will be appreciated that the rear doors may also take the form of a roller door, as is well known in the art. The trailer 18 is carried by two axels that support two sets of tires 28a, 28b, and 30a, 30b.

The person of ordinary skill will recognize the tractor trailer truck 15 shown in FIG. 1 to be representative of an “18 wheel” tractor trailer truck configuration. The person of ordinary skill in the art will further appreciate that said “18 wheel” tractor trailer truck configuration is merely representative and not limiting as the present invention may be readily adapted to any vehicle that has air brakes, including any other trucks, tractors, trailers and braking configurations that utilize air brakes. Further, the person of ordinary skill will recognize that the disclosed and claimed inventions are readily adapted to trucks that utilize a hydraulic fluid, including but not limited to compressed air, as a medium by which to activate the brake assemblies. Thus, while the present invention is described in reference to an “18 wheeler” tractor trailer truck, the invention is applicable to a wide variety of other tractors, trailers, trucks and vehicles.

A tractor trailer truck brake system is identified generally at 40. The brake system 40 includes a service brake system 42 and a parking brake system 43. The brake systems 42 and 43 are comprised of several components. A compressor 50 is provided that compresses and pumps air. The compressor 50 is driven by the tractor's engine and conventionally provided with a governor (not shown) to control the air pressure in the brake system. The compressor 50 is running whenever the tractor engine is running. When pressure in the brake system 40 is adequate, it is not necessary for the compressor to pump air. The governor controls the minimum and maximum air pressure in the brake system 40 by controlling when the compressor pumps air to insure that there is an adequate supply of appropriately compressed air for use by both the service system 42 and the emergency parking system 43.

The compressor 50 delivers air to a dryer 55 and thereafter to a reservoir 60 that contains the compressed air supply. Many vehicles are equipped with more than one reservoir for purposes of redundancy and to insure an adequate supply of compressed air to insure operation of the brake system 40. For example, a second reservoir 62 is provided in the tractor 17. For convenience, the first reservoir 60 may be referred to as the primary reservoir. Any other or remaining reservoirs, such as that shown at 62, may be referred to as secondary reservoirs. The person of ordinary skill in the art will appreciate that the present invention is readily adapted to any number of reservoirs.

The person of ordinary skill will appreciate that the service brake system 42 includes a foot valve or brake pedal (treadle) 65 that regulates the flow of compressed air and causes the service brakes to be applied in the usual manner. More particularly, compressed air may be delivered from the reservoirs 60 or 62 to a plurality of tractor brake assemblies 71, 72, 73, 74, 75 and 76. The brake assemblies 71-76 facilitate the service brake system in a conventional manner.

The person of ordinary skill will also appreciate that the brake assemblies 71-76 further include a spring brake parking or emergency brake system 43 wherein the brakes are applied by spring pressure and released by air pressure. The person of ordinary skill will further appreciate that brake assemblies 71-2 may be disc brakes and may not include a spring parking brake. Accordingly, the following description of the tractor brakes will focus on brake assemblies 73-76. Conventionally, the emergency or parking brake chambers of assemblies 73-76 may be attached to the service brake chambers and operate by means of many of the same linkage elements. In the emergency or parking brake system of the tractor 17, the brakes 73-76 are applied by spring action and released by air pressure. Operation of the tractor emergency or parking brake system 43 is known in the art. Accordingly, for convenience, the same reference numerals 73-76 are used to indicate both the tractor service brake and the spring (parking) brake components.

As is known in the art, a loss of compressed air from the emergency braking system 43 will cause the springs to apply the brakes of the brake assemblies 73-76, thereby acting as a parking brake. Further, a supply of compressed air to the brake assembles 73-76 will cause the springs to release the parking brake to permit free movement of the tractor 17. With regard to the tractor emergency brake system 43, the supply of compressed air releases the brake of the brake assemblies 73-76, whereas the release of compressed air allows the springs of the brake assemblies 73-76 to apply the parking brakes. Of course, in the event of a loss of air pressure in the system during operation of the tractor 17, the springs act to engage the brakes of the brake assemblies 73-76, which also act as an emergency brake to assist in stopping the tractor 17.

The trailer 18 includes a brake system 90. The trailer emergency brake system 90 is conventionally coupled to the tractor brake system 40 by use of “glad hands” connectors 92 and 93 that facilitate connection of the tractor service brake system 42 to the trailer service brake system and connection of the tractor parking brake system 43 to the trailer parking or emergency brake system, respectively. The person of ordinary skill will recognize that the glad hands connectors 92 and 93 are typically provided on the driver's side of the tractor 17. More particularly, the connector 93 connects the tractor's emergency brake line 93a and the trailer's emergency brake line 93b. A similar connection is made for the service lines 92a and 92b by means of connector 92. Those of ordinary skill in the art will recognize that the service line is conventionally blue in color whereas the emergency line is conventionally red in color. Since the service brake system may otherwise be conventional in construction and operation, it is not further addressed.

The trailer brake system 90 includes an emergency air line 93b that delivers compressed air to the trailer's service brake system. As stated above, a tractor conventionally includes a tractor parking brake valve and a trailer parking brake valve. Once the driver has positioned the tractor and trailer as desired, the driver will manipulate the tractor parking brake valve to release compressed air from the tractor brake system and thereby apply the tractor parking brakes. Similarly, the driver will manipulate the trailer parking brake valve to release compressed air from the trailer brake system and thereby apply the trailer parking brakes. It is also known to provide for the two valves to cooperate such that when the truck driver manipulates the tractor parking brake valve, the trailer parking brake valve is simultaneously activated so that both the tractor and trailer parking brakes are applied. It is therefore to be understood that the tractor cabin 19 includes a valve 80 in emergency air line 93a that can be manipulated by the truck driver. In conventional operation, the truck driver would manipulate the emergency air line valve 80 to supply or to release compressed air to the emergency brake system and release the parking brake in the tractor 17. However, if desired, the release of compressed air in the emergency brake system may be organized such that when the truck driver manipulates the tractor parking brake valve, the trailer parking brake valve 80 is simultaneously activated.

The trailer brake system 90 includes brake assemblies 95, 96, 97 and 98. The trailer brake assemblies 95-98 are substantially identical to the tractor brake assemblies 73-76. Importantly, the trailer brake assemblies 95-98, as explained previously in reference to the tractor brake assemblies 73-76, include springs that cause the brakes of brake assemblies 95-98 to be applied when compressed air is released from the trailer brake system 90. Similarly, when compressed air is supplied to the trailer brake system 90, the brakes of assemblies 95-98 are released (not applied) and the trailer is free to be moved by the tractor 17. The details of the construction of the brake assemblies 71-76 and 95-98 are well known and further description of the such assemblies is unnecessary because such assemblies are well known to the person of ordinary skill in the art.

As shown, the trailer 18 is fitted with two secondary reservoirs 99a and 99b. The reservoirs 99a and 99b are supplied with compressed air by the compressor 50 by means of the glad hand connector 93 and a trailer emergency air line 93b, thus insuring sufficient compressed air for proper operation of the emergency brakes 95-98 (as supplied by lines 93a/93b). Thus, the reservoirs 99a and 99b are in fluid communication with the brake assemblies 95, 96 and 97, 98 and are capable of supplying compressed air to all of the brake assemblies.

As further shown in the drawings, the safety valve 10 is placed in the trailer's emergency brake system air line 93b. The safety valve 10 is preferably located within a compartment 100 located in the driver side sidewall 102 of the trailer 18 near the rear end thereof. Preferably, the safety valve 10 is located behind a vertically sliding door 103 that is accessible from the interior of the trailer 18 and adapted to move between an open position and a closed position. See FIG. 1. Those of ordinary skill in the art will appreciate that the compartment 100 is to be narrow in construction and not protrude into the trailer 18 so that the compartment does not influence or interrupt loading or unloading of the trailer 18. The compartment 100 is preferably of a dimension to fit wholly within the sidewall 102 of the trailer 18. If necessary, the compartment 100 may protrude outwardly of the trailer sidewall 102 and, if desired, fitted with a wind shield or other aerodynamic device to facilitate operation. Preferably, the sliding door 103 is similarly constructed so as not to protrude into the trailer 18. For example, the door 103 may be provided with an integral aperture or an indented finger grip (not shown) so as to manipulated with one digit. Such a construction is preferred to create a flat surface with no projection into the trailer 18. The door 103 may be constructed to withdraw into the compartment 100 in an accordion-like fashion, or otherwise. The detail of any such construction is within the skill of the person of ordinary skill. Further, the door 103 may be biased into a closed position such that once a user removes his or her finger from any indentation or aperture, the door returns to a closed position. The sliding door 103 will thus prevent the safety valve 10 from being damaged or accidentally actuated by falling freight or contact with a lift truck or stored item. The narrow profile of the compartment 100 will also preclude the safety valve 10 from being unintentionally rotated (open or closed) when the door 103 is in a closed position, whether the trailer 18 is at a dock or being moved by the tractor 17. Should freight or another object fall or lodge against the door 103, such will effectively wedge the door against the handle 200 (see below) and preserve the safety valve's 10 position.

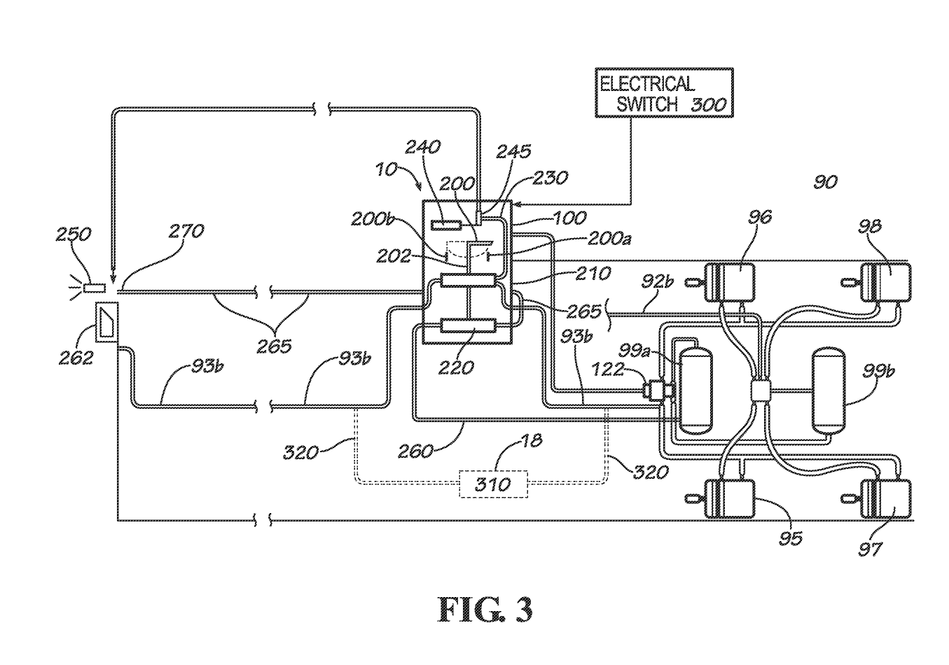

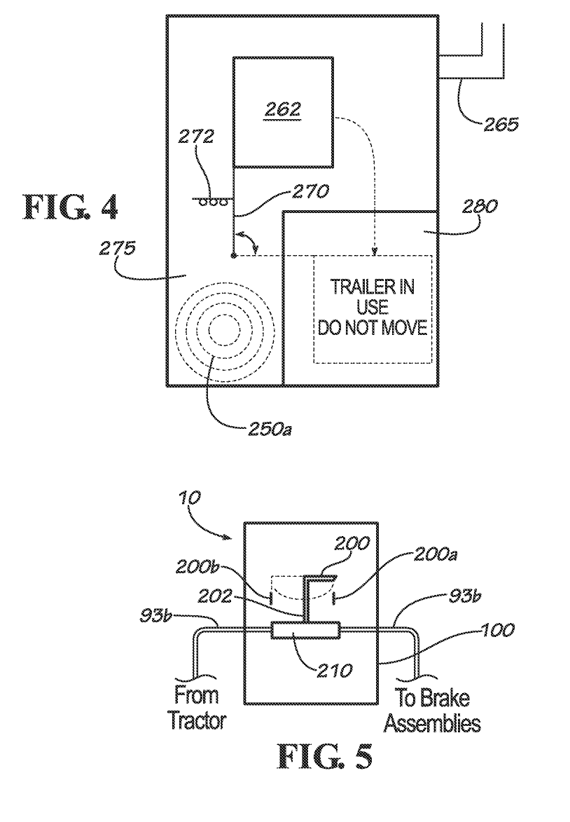

It is to be understood that the safety valve 10 may have multiple chambers. The valve 10 may readily be a 2-way valve or a 3-way valve. The safety valve chambers may be provided in a single device or multiple devices. The safety valve 10 shown in FIG. 3 has a handle 200, a stem 202 and two chambers 210 and 220. It is to be understood that valve 10 could be provided with a single chamber 210, or with additional chambers depending on the uses to be made as described herein. In the device shown in FIG. 3, the valve stem 202 extends through or past the chamber 210 into the chamber 220. Thus, by turning the handle 200, a user may simultaneously manipulates both chambers 210 and 220. As described herein, it is to be understood that in such an arrangement, the chamber 210 is to be closed when the chamber 220 is open, and vise versa. Other arrangements may of course be provided within the scope of the present invention. More particularly, it will be appreciated that the handle 200 shown in FIGS. 3 and 4 may be rotated from a first position 200a to a second position 200b to affect either opening or closing of chamber 210. As shown, it will be therefore appreciated that by manipulating the handle 200, the flow of compressed air in line 93b can be blocked and diverted. When the handle 200 is at position 200a, the chamber 210 is open such that compressed air can flow through the valve 10 to the trailer brake system 90 to release the parking brake in assemblies 95-98. However, when handle 200 is rotated to position 200b, the chamber 210 of safety valve 10 is closed, which blocks the flow of compressed air to the brake assemblies 95-98 and maintains the parking or emergency brake.

In another embodiment, the safety valve 10 may appear as in FIG. 5, with a single chamber 210 in fluid communication with trailer emergency brake air line 93b. In this embodiment, compressed air received by the chamber 210 is either delivered through air line 93b to the brake system 90 to release the trailer emergency brakes 95-98 or, by rotating the handle 200 to position 200b, the safety valve 10 blocks the flow of compressed air and thus prevents any release of the trailer's emergency brakes 95-98. In this manner, the present invention can provide a forklift operator control to override the trailer brake system and prevent premature or inadvertent movement of the trailer 18 until the valve 10 is opened by rotating handle 200 back to position 200a. Further, the person of ordinary skill in the art will appreciate that various valve stem and handle configurations are possible. For example, the valve may be in the nature of a lever or U-shape so that it can be placed flush with the trailer sidewall and flipped from one side to the other to manipulate the valve stem. In such an arrangement, it would be preferable for the lever or U-shaped handle to be spring loaded such that whenever the handle was moved from one side to the other, a spring would bias the handle in the direction of its movement so that it was secured in a given position. In that manner, should the handle be moved to the open valve position, the spring bias would case the handle to remain in that position. Similarly, should the handle be moved into the closed position, it would be biased so as to remain in that position.

A safety valve 10 according to the present invention provides other alternative preferred embodiments that not only block the flow of compressed air through the chamber 210, but also divert the compressed air to associated devices that are capable of alerting a truck driver or other person that the trailer 18 is in use and not ready to be moved. Referring in more detail to FIG. 3, it is shown that a second air line 230 is provided that connects to a whistle 240 through a “t” connector 245. The whistle 240 is powered by compressed air flow and capable of sounding an aural alert. The details of providing and sounding such a whistle are known to the person(s) of ordinary skill in the art.

The alternative preferred embodiment shown in FIG. 3 further includes an air line 247 that extends from the other side of the “t” connector 245 to the front outside of the trailer 18 to engage an air horn 250. The air horn 250, which may also be an air whistle or other appropriate sound device, may be positioned on the front nose of the trailer 18 so as to alert a truck driver or other person located in the vicinity of the cabin 19 or the tractor 17 or otherwise in front of the trailer 18. The air horn (or horns) 250 are powered by compressed air in a conventional manner. With specific reference to the form of the invention shown in FIG. 3, the person of ordinary skill will appreciate that when the chamber 210 is closed by rotation of the handle 200, the compressed air delivered by way of air line 93b may be directed to the air whistle 240 and the air horn 250 in order to sound alert alarms both inside (by means of the whistle 240) and outside of the trailer 18 (by means of the air horn 250).

As described above, the alternative preferred embodiment shown in FIG. 3 further includes a second chamber 220. As shown, chamber 220 of the safety valve 10 is in fluid communication with secondary reservoir 99a by means of an air line 260. Further, this alternative preferred embodiment includes an alert flag 262 that is in fluid communication with chamber 220 by means of air line 265. Directing compressed air to the alert flag 262 causes a display flag to be deployed, which preferably warns: “TRAILER IN USE DO NOT MOVE,” as shown in FIG. 4. The notice may be comprised of any suitable language. The alert flag 262 is preferably hingably mounted on an arm 270 that is biased by a spring 272 into a withdrawn position behind a metal plate 275 or like enclosure when no compressed air is being delivered thereto. However, when compressed air is delivered to the alert flag 262 via air line 265, the arm 270 is deployed or rotated into position before a glass 280 or other transparent material to reveal the notification. Once compressed air is no longer delivered to the alert flag 262, there is a release of compressed air from the system such that the arm 270 retracts the flag 262 to withdraw the written warning. The details of providing a display of a notice flag 262 in response to or powered by compressed air is within the purview of a person of ordinary skill in the art. Moreover, as shown in FIG. 4, the air horn 250 may be provided in a single compartment with a grill 250a or the like to facilitate transmission of the air horn sound to the exterior of the compartment. However, as shown in FIG. 3, the air horn may also be provided on the front of the trailer 18. It is to be understood that the alert flag 262 is displayed once the valve 10 is manipulated to open the chamber 220 such that the warning is provided while the trailer 18 is being loaded and unloaded, or until the chamber 220 is closed by manipulation of the handle 200.

Thus, from the foregoing it will be understood that the present invention addresses the premature or inadvertent movement of a trailer 18. A forklift operator or other person closes the safety valve 10 so as to block and divert compressed air in chamber 210 to the air whistle 240 and air horns 250, and opens the chamber 220 so that compressed air can flow from the reservoir 99a to power the alert flag 262. In the event a truck driver prematurely manipulates the vale 80 in the emergency line 93a of the tractor 17, compressed air is delivered to the emergency air line 93b of the trailer 18. The compressed air is blocked from reaching the trailer brake system 90 and the brake assemblies 95-98, thus insuring that the emergency brake remains applied by action of the springs. Instead, the compressed air is directed by the safety valve 10 to the air whistle 240 and the air horns 250. The whistle 240 and the horns 250 sound to alert the driver that the trailer 18 is still in use. Further, by opening chamber 220, compressed air is delivered to the alert flag 262, which provides a visual alert that the trailer 18 is still in use and should not be moved, in accord with display language to that effect as shown in FIG. 4. Once the unloading or loading process is complete, the forklift operator or other person rotates the handle 200 of the valve to open chamber 210 so that compressed air may be delivered to the trailer brake system 90 and release the brakes in assemblies 95-98 so that the trailer can be moved. Such rotation of the valve handle 200 simultaneously closes the chamber 220 and thus prevents the flow of compressed air to the flag alert 262, allowing the spring-biased display to be withdrawn. See FIG. 4. Further, when valve handle 200 is rotated to a position 200b, the chamber 210 is “closed” such that air is diverted to the whistle 240 and the air horn 250, and the chamber 220 is “open” such that air flows from the reservoir 99a to the alert flag display 262. When the valve handle 200 is rotated to a position 200a, the chamber 210 is “open” such that compressed air is directed to the trailer brake system so that the parking brakes are released and the whistle 240 and horns 250 do not sound, and the chamber 220 is “closed” such that compressed air from the reservoir 99a is prevented from reaching the alert flag 262 display so that it is withdrawn.

Yet further, it is to be appreciated that the present invention may include an electrical switch 300 that may be used to activate the safety valve 10 by causing manipulation of the stem 202. Further, the invention may further include an override release valve 310 at any suitable location, such as the bottom of the trailer 18, in fluid communication with the safety valve 10 by means of a line 320 that would allow one to release override the safety valve 10. The override release valve 310, if desired, comprises a valve placed within the emergency brake system 90 of the trailer, specifically placed within the line 93b. The override release valve 310 would operate such that when opened, the valve 310 would allow compressed air to by-pass the safety valve 10 and reach the brake assemblies 95-98 so as to release the emergency or parking brakes thereof. “T” connectors may be used to effect connection of the air line 320 to air line 93b. See FIG. 3. The construction and operation of the override release valve 310, in view of the foregoing, is within the skill of one of ordinary skill in the art.

Those of ordinary skill in the art will appreciate that the foregoing description of the embodiments are written to the person of ordinary skill in the art, who may make various modifications thereto that are within the scope of the invention as defined by the below and within claims.

1. A safety valve for a trailer having an emergency parking brake system, comprising:
a compressed air source;
an air line for delivering compressed air so as to release at least one parking brake associated with a trailer, said parking brake being releaseable by means of a delivery of compressed air thereto;
a valve interposed within said air line for blocking the flow of compressed air to said at least one parking brake of said trailer, said valve defining a chamber; and
a handle for selectively closing said chamber of said valve interposed within said air line such that closing said valve precludes compressed air from reaching said at least one parking brake such that said at least one parking brake is not released and said trailer is not readily moved.

2. The safety valve of claim 1 further comprising a sound device in fluid communication with said chamber of said valve whereby selective closing of said chamber diverts a flow of compressed air to said sound device so as to alert persons of the changed condition represented by the flow of compressed air to said chamber.

3. The safety vale of claim 2 further comprising a second chamber in fluid communication with said compressed air source and an alert flag whereby selective opening of said second chamber causes compressed air to be delivered to said alert flag so as to deploy said alert flag and display a message.

4. The safety valve of claim 4 wherein the message includes a statement that the trailer is in use.

5. A safety valve for a trailer to be used with a tractor, the tractor including a compressed air source, emergency spring parking brakes responsive to compressed air, an emergency brake air line and an emergency brake valve positioned in said emergency brake line for supplying compressed air to said tractor emergency brake line, and the trailer including emergency spring parking brakes responsive to compressed air and an emergency brake air line connected to said tractor emergency brake air line for receipt of compressed air from said tractor and delivery of compressed air to the trailer spring parking brakes, the improvement comprising:
a valve positioned in a trailer emergency brake line, said valve including a first chamber in fluid communication with said trailer emergency brake line;
a first air powered sound device in fluid communication with and located in close proximity to said first chamber of said valve in said trailer emergency brake line; and
a second air powered sound device in fluid communication with and located remotely of said first chamber of said valve in said trailer emergency brake line;
whereby, upon manipulation of said valve in said trailer emergency brake line, compressed air flow from said tractor to said trailer emergency brake line is prevented from reaching said trailer spring parking brakes so that said trailer parking brakes remain applied, and instead, said compressed air is directed to said first air powered sound device and said second air powered sound device, such that, upon manipulation of said emergency brake valve in said tractor, compressed air in said emergency brake line is diverted to said first and second air powered sound devices so as to alert persons both in close proximity and remote of said valve in the trailer emergency brake line, and compressed air is prevented from reaching said trailer emergency spring brakes such that the parking brakes remain applied.

6. The safety valve of claim 5 wherein said valve in said trailer emergency brake line is located at least partially within a sidewall of a trailer.

7. The safety valve of claim 6 wherein said valve is accessible only from the interior of said trailer.

8. The safety valve of claim 5 wherein manipulation of said valve in said trailer emergency brake line is accomplished by an electric switch powered by said tractor such that manipulation of said switch causes said valve to be open or closed so as to correspondingly apply or release said trailer spring parking brakes.

9. The safety valve of claim 5 further including an override release valve that permits compressed air to bypass the valve in said trailer emergency brake line so as to allow compressed air to release said trailer spring parking brakes.

10. The safety valve of claim 5 further including a second chamber in fluid communication with a compressed air reservoir and an alert display responsive to compressed air, such that upon a first manipulation of said valve in said trailer emergency brake line, compressed air is delivered to said alert display such that a visual message is presented and, upon a second manipulation of said valve in said trailer emergency brake line, compressed air is vented from said alert display such that said visual message is withdrawn.
